(19) United States
(12) Patent Application Publication
(10) Pub. No.: US 2026/0221330 A1
(43) Pub. Date: Jul. 30, 2026

(54) COIL COMPONENT

(71) Applicant: TDK CORPORATION, Tokyo (JP)

(72) Inventors: Yusaku KUSANAGI, Tokyo (JP); Yasushi MATSUYAMA, Tokyo (JP); Yuto SHIGA, Tokyo (JP)

(73) Assignee: TDK CORPORATION, Tokyo (JP)

(21) Appl. No.: 19/453,475

(22) Filed: Jan. 20, 2026

(30) Foreign Application Priority Data
Jan. 27, 2025 (JP) 2025-011337

(51) Int. Cl. H01F 27/245; H01F 27/28

(52) U.S. Cl. CPC H01F 27/245; H01F 27/2823

(57) ABSTRACT

A coil component includes an element body made of an insulator including Al₂O₃ filler, and a coil disposed in the element body. The element body includes: a first region in which the coil is located, the first region including plate-like Al₂O₃ filler and granular Al₂O₃ filler as the Al₂O₃ filler; and a pair of second regions located on both sides of the first region, the pair of second regions including plate-like Al₂O₃ filler and granular Al₂O₃ filler as the Al₂O₃ filler. Each of the pair of second regions has a total content of the Al₂O₃ filler larger than a total content of the Al₂O₃ filler in the first region, and has a content of the plate-like Al₂O₃ filler smaller than a content of the plate-like Al₂O₃ filler in the first region.

### CROSS-REFERENCE TO RELATED APPLICATIONS

This application is based upon and claims the benefit of priority from Japanese Patent Application No. 2025-011337, filed on January 27, 2025, the entire contents of which are incorporated herein by reference.

### BACKGROUND

### Field

One aspect of the present disclosure relates to a coil component.

### Description of the Related Art

Known coil components include an element body made of an insulator including Al₂O₃ filler, and a coil disposed in the element body (for example, refer to Japanese Unexamined Patent Publication No. 2023-76264).

### SUMMARY

A coil component according to one aspect of the present disclosure includes an element body made of an insulator including Al₂O₃ filler, and a coil disposed in the element body. The element body includes: a first region in which the coil is located, the first region including plate-like Al₂O₃ filler and granular Al₂O₃ filler as the Al₂O₃ filler; and a pair of second regions located on both sides of the first region, the pair of second regions including plate-like Al₂O₃ filler and granular Al₂O₃ filler as the Al₂O₃ filler. Each of the pair of second regions has a total content of the Al₂O₃ filler larger than a total content of the Al₂O₃ filler in the first region, and has a content of the plate-like Al₂O₃ filler smaller than a content of the plate-like Al₂O₃ filler in the first region.

### BRIEF DESCRIPTION OF THE DRAWINGS

FIG. 1 is a perspective view illustrating a coil component according to an example;

FIG. 2 is an exploded perspective view illustrating the coil component;

FIG. 3 is a diagram illustrating a coil and external conductors; and

FIG. 4 is a diagram illustrating a cross-sectional configuration of an element body.

### DETAILED DESCRIPTION

In the following description, with reference to the drawings, the same reference numbers are assigned to the same components or to similar components having the same function, and overlapping description is omitted.

One aspect of the present disclosure provides a coil component that suppresses an increase in relative permittivity and a decrease in the strength of an element body, and suppresses the occurrence of cracks in the element body.

One aspect of the present disclosure relates to a coil component that includes an element body made of an insulator including Al₂O₃ filler, and a coil disposed in the element body. The element body includes: a first region in which the coil is located, the first region including plate-like Al₂O₃ filler and granular Al₂O₃ filler as the Al₂O₃ filler; and a pair of second regions located on both sides of the first region, the pair of second regions including plate-like Al₂O₃ filler and granular Al₂O₃ filler as the Al₂O₃ filler. Each of the pair of second regions has a total content of the Al₂O₃ filler larger than a total content of the Al₂O₃ filler in the first region, and has a content of the plate-like Al₂O₃ filler smaller than a content of the plate-like Al₂O₃ filler in the first region.

In the one aspect described above, the first region and the second region include the Al₂O₃ filler. Therefore, the one aspect described above improves the strength of the element body.

The Al₂O₃ filler tends to increase the relative permittivity of the element body. The coil is located in the first region. The first region in which the coil is located tends to contribute to the characteristics of the coil, as compared with the second region. In the one aspect described above, the total content of the Al₂O₃ filler in the first region is smaller than the total content of the Al₂O₃ filler in the second region. The one aspect described above suppresses an increase in the relative permittivity of the element body. In the one aspect described above, the total content of the Al₂O₃ filler in the second region is larger than the total content of the Al₂O₃ filler in the first region. The one aspect described above suppresses a decrease in the strength of the element body.

In the one aspect described above, the first region and the second region include the plate-like Al₂O₃ filler and the granular Al₂O₃ filler. In the one aspect described above, a rapid structural change tends not to occur between the first region and the second region, as compared with a configuration in which one of the first region and the second region includes plate-like Al₂O₃ filler and the other of the first region and the second region includes granular Al₂O₃ filler. For example, a difference between the shrinkage rate of the first region and the shrinkage rate of the second region tends not to be large. Therefore, internal stress tends not to occur in the element body. The one aspect described above suppresses the occurrence of cracks in the element body.

The plate-like Al₂O₃ filler, for example, tends to be oriented in a predetermined direction. In a region including the plate-like Al₂O₃ filler, a difference in strength may occur between a direction in which the plate-like Al₂O₃ filler is oriented and a direction other than the direction in which the plate-like Al₂O₃ filler is oriented. The difference in strength due to the direction in which the plate-like Al₂O₃ filler is oriented may cause cracks to occur in the region including the plate-like Al₂O₃ filler when an external force is applied.

In the one aspect described above, the content of the plate-like Al₂O₃ filler in the second region is smaller than the content of the plate-like Al₂O₃ filler in the first region. In the second region that is located outside the first region and protects the first region, a difference in strength due to the direction in which the plate-like Al₂O₃ filler is oriented tends not to occur. Therefore, even when an external force is applied to the second region, cracks tend not to occur in the second region. The one aspect described above tends not to degrade the function of the second region to protect the first region.

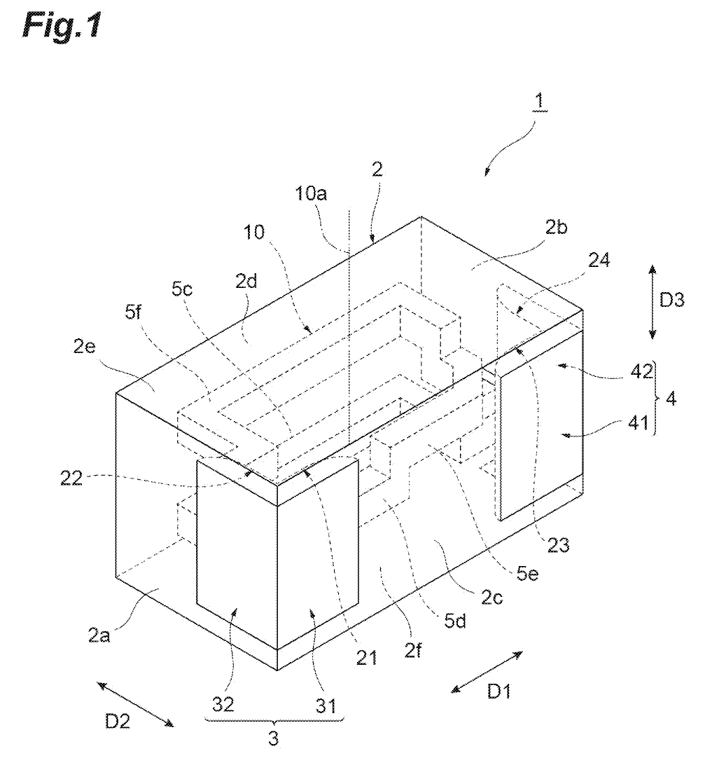

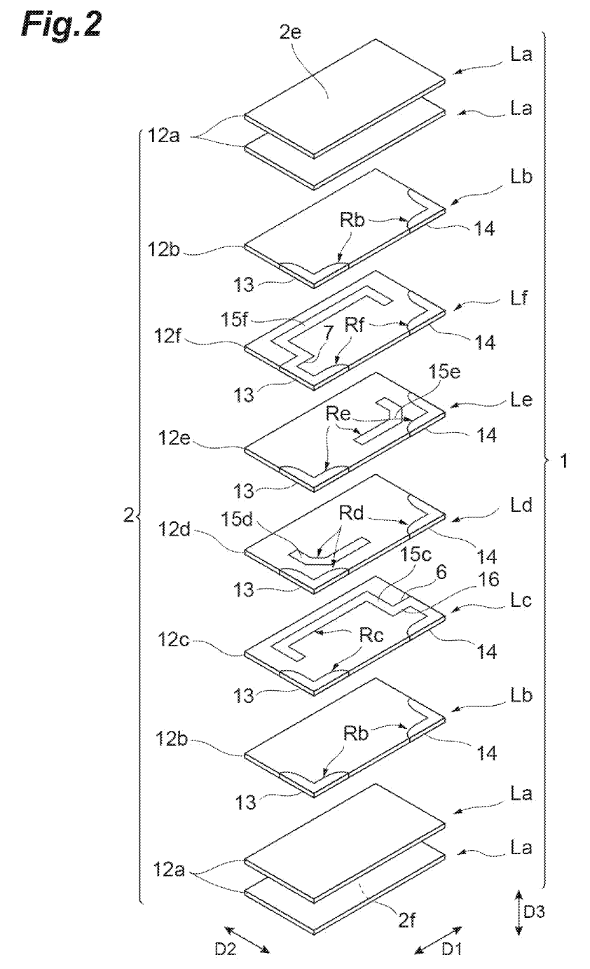

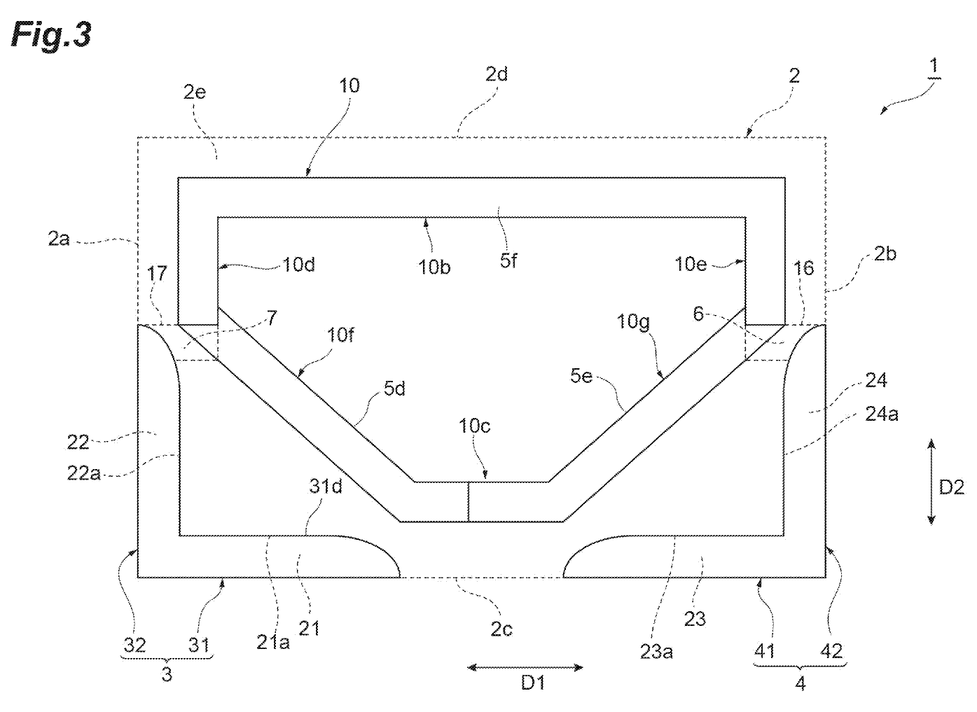

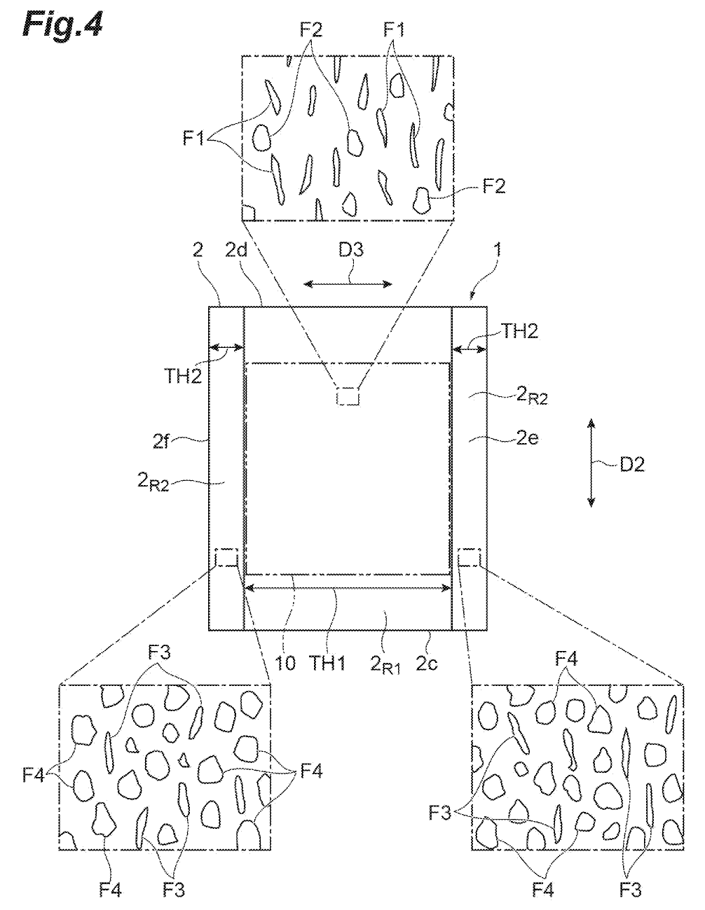

A configuration of a coil component 1 according to an example will be described with reference to FIGS. 1 to 4. FIG. 1 is a perspective view illustrating a coil component according to an example. FIG. 2 is an exploded perspective view illustrating the coil component. FIG. 3 is a diagram illustrating a coil and external conductors. FIG. 4 is a diagram illustrating a cross-sectional configuration of an element body.

As illustrated in FIGS. 1 to 3, the coil component 1 includes an element body 2, a plurality of external conductors 3 and 4, a plurality of coil conductors 5c, 5d, 5e, and 5f, and a plurality of connection conductors 6 and 7. The coil component 1 includes, for example, two external conductors 3 and 4. The coil component 1 includes, for example, two connection conductors 6 and 7. The coil component 1 includes, for example, a multilayer coil component. The manufacturing process of the coil component 1 may include the manufacturing process disclosed in Japanese Unexamined Patent Publication No. 2023-76264.

The element body 2 has, for example, a rectangular parallelepiped shape. The rectangular parallelepiped shape includes, for example, a rectangular parallelepiped shape in which corners and ridges are chamfered, or a rectangular parallelepiped shape in which corners and ridges are rounded. The element body 2 includes a pair of end surfaces 2a and 2b, and four side surfaces 2c, 2d, 2e, and 2f. The pair of end surfaces 2a and 2b oppose each other in a direction D1. The side surface 2c and the side surface 2d oppose each other in a direction D2. The side surface 2e and the side surface 2f oppose each other in a direction D3. The direction D1, the direction D2, and the direction D3 are, for example, substantially perpendicular to each other.

The pair of end surfaces 2a and 2b extend in the direction D2 to couple the side surface 2c and the side surface 2d. The pair of end surfaces 2a and 2b extend in the direction D3 to couple the side surface 2e and the side surface 2f. The side surface 2c and the side surface 2d extend in the direction D1 to couple the pair of end surfaces 2a and 2b. The side surface 2c and the side surface 2d extend in the direction D3 to couple the side surface 2e and the side surface 2f. The side surface 2e and the side surface 2f extend in the direction D2 to couple the side surface 2c and the side surface 2d. The side surface 2e and the side surface 2f extend in the direction D1 to couple the pair of end surfaces 2a and 2b.

The coil component 1 is mounted on an electronic device. For example, the coil component 1 is solder-mounted on the electronic device. The electronic device includes, for example, a circuit board or an electronic component. In the coil component 1, for example, the side surface 2c opposes the electronic device. The side surface 2c is arranged to constitute a mounting surface. The side surface 2c includes the mounting surface. The pair of end surfaces 2a and 2b are continuous with the mounting surface, that is, the side surface 2c.

A length of the element body 2 in the direction D1 is, for example, larger than a length of the element body 2 in the direction D2 and a length of the element body 2 in the direction D3. The length of the element body 2 in the direction D2 and the length of the element body 2 in the direction D3 are, for example, equivalent to each other. The pair of end surfaces 2a and 2b have, for example, a square shape. The four side surfaces 2c, 2d, 2e, and 2f have, for example, a rectangular shape having long sides and short sides. The pair of end surfaces 2a and 2b and the four side surfaces 2c, 2d, 2e, and 2f have, for example, a rectangular shape. The rectangular shape includes, for example, a shape in which each corner is chamfered, or a shape in which each corner is rounded. The length of the element body 2 in the direction D1 may be equivalent to the length of the element body 2 in the direction D2 and the length of the element body 2 in the direction D3, and may be smaller than the length of the element body 2 in the direction D2 and the length of the element body 2 in the direction D3. The length of the element body 2 in the direction D2 and the length of the element body 2 in the direction D3 may be different from each other.

In the present specification, "equivalent" does not necessarily mean only that a plurality of values are identical. Even when a slight difference within a preset range, a manufacturing error, or a measurement error is included, the plurality of values may be considered to be equivalent. For example, when each of a plurality of values falls within a range of ±5% of an average value of the plurality of values, the plurality of values are defined as being equivalent.

A plurality of recesses 21, 22, 23, and 24 are formed in the element body 2. The recess 21 and the recess 22 are formed to be continuous with each other and correspond to the external conductor 3. The recess 23 and the recess 24 are formed to be continuous with each other and correspond to the external conductor 4.

The recess 21 is located on the side surface 2c near the end surface 2a and is recessed toward the side surface 2d. The recess 21 has a bottom surface 21a. The bottom surface 21a has, for example, a rectangular shape. The recess 22 is located on the end surface 2a near the side surface 2c and is recessed toward the end surface 2b. The recess 22 has a bottom surface 22a. The bottom surface 22a has, for example, a rectangular shape. The recess 23 is located on the side surface 2c near the end surface 2b and is recessed toward the side surface 2d. The recess 23 has a bottom surface 23a. The bottom surface 23a has, for example, a rectangular shape. The recess 24 is located on the end surface 2b near the side surface 2c and is recessed toward the end surface 2a. The recess 24 has a bottom surface 24a. The bottom surface 24a has, for example, a rectangular shape.

The recesses 21, 22, 23, and 24 have, for example, the same shape. The recesses 21, 22, 23, and 24 are spaced apart from the side surfaces 2d, 2e, and 2f. The recesses 21, 22, 23, and 24 are not formed on the side surfaces 2d, 2e, and 2f. The recess 21 and the recess 23 are spaced apart from each other in the direction D1.

The element body 2 is configured through laminating a plurality of element-body layers 12a to 12f. The element body 2 includes the plurality of laminated element-body layers 12a to 12f. In the element body 2, a lamination direction of the plurality of element-body layers 12a to 12f coincides with the direction D3. In an actual element body 2, the plurality of element-body layers 12a to 12f are integrated to an extent that boundaries between the layers cannot be visually recognized. The plurality of element-body layers 12a to 12f include an insulator. The plurality of element-body layers 12a to 12f are made of an insulator. The insulator, for example, includes a non-magnetic material. The element body 2, for example, is made of an insulator. The non-magnetic material, for example, includes glass-ceramic. The element body 2, for example, is made of glass-ceramic.

The external conductor 3 is disposed in the recesses 21 and 22. The external conductor 4 is disposed in the recesses 23 and 24. The external conductor 3 and the external conductor 4 are separated from each other in the direction D1. For example, the external conductor 3 and the external conductor 4 have the same shape. For example, the external conductor 3 and the external conductor 4 have an L-shaped cross-section. For example, the external conductor 3 and the external conductor 4 have an L-shape when viewed from the direction D3. The L-shape may be a shape that is a substantially L-shape as a whole. For example, even in a configuration in which unevenness is formed on the surfaces of the external conductors 3 and 4, the external conductors 3 and 4 may have a shape that is an L-shape as a whole.

A plating layer may be disposed on an outer surface of each of the plurality of external conductors 3 and 4. The plating layer is formed, for example, through an electrolytic plating process or an electroless plating process. The plating layer includes, for example, Ni, Sn, or Au.

The external conductor 3 is configured through laminating a plurality of conductor layers 13. The external conductor 3 includes the plurality of laminated conductor layers 13. Each conductor layer 13 has an L-shape when viewed from the direction D3. In the external conductor 3, a lamination direction of the plurality of conductor layers 13 coincides with the direction D3. In an actual external conductor 3, the plurality of conductor layers 13 are integrated to an extent that boundaries between the layers cannot be visually recognized. The external conductor 3 includes a plurality of conductor portions 31 and 32. The plurality of conductor portions 31 and 32 are integrally formed. The external conductor 3 includes, for example, two conductor portions 31 and 32. Each of the plurality of conductor portions 31 and 32 has a substantially rectangular plate shape. The conductor portion 31 and the conductor portion 32 have, for example, the same shape. The conductor portion 31 is disposed in the recess 21. The conductor portion 31 is disposed on the side surface 2c. The conductor portion 32 is disposed in the recess 22. The conductor portion 32 is disposed on the end surface 2a.

The external conductor 4 is configured through laminating a plurality of conductor layers 14. The external conductor 4 includes the plurality of laminated conductor layers 14. Each conductor layer 14 has an L-shape when viewed from the direction D3. In the external conductor 4, a lamination direction of the plurality of conductor layers 14 coincides with the direction D3. In an actual external conductor 4, the plurality of conductor layers 14 are integrated to an extent that boundaries between the layers cannot be visually recognized. The external conductor 4 includes a plurality of conductor portions 41 and 42. The plurality of conductor portions 41 and 42 are integrally formed. The external conductor 4 includes, for example, two conductor portions 41 and 42. Each of the plurality of conductor portions 41 and 42 has a substantially rectangular plate shape. The conductor portion 41 and the conductor portion 42 have, for example, the same shape. The conductor portion 41 is disposed in the recess 23. The conductor portion 41 is disposed on the side surface 2c. The conductor portion 42 is disposed in the recess 24. The conductor portion 42 is disposed on the end surface 2b.

The plurality of coil conductors 5c, 5d, 5e, and 5f are disposed in the element body 2 and are connected to each other. The plurality of coil conductors 5c, 5d, 5e, and 5f constitute a coil 10. The coil component 1 includes the coil 10 disposed in the element body 2. The coil component 1 includes, for example, four coil conductors 5c, 5d, 5e, and 5f. The coil 10 is disposed such that a coil axis 10a is along the direction D3. Among the plurality of coil conductors 5c, 5d, 5e, and 5f, coil conductors adjacent to each other in the direction D3 are disposed such that at least a part thereof overlap each other as viewed from the direction D3. The plurality of coil conductors 5c, 5d, 5e, and 5f are spaced apart from the pair of end surfaces 2a and 2b and four side surfaces 2c, 2d, 2e, and 2f.

As illustrated in FIG. 3, the coil 10 has, for example, a polygonal shape as viewed from the direction D3. The coil 10 has, for example, a hexagonal shape as viewed from the direction D3. The coil 10 includes a plurality of portions 10b, 10c, 10d, 10e, 10f, and 10g. The coil 10 includes, for example, six portions 10b, 10c, 10d, 10e, 10f, and 10g.

The plurality of portions 10b, 10c, 10d, 10e, 10f, and 10g are disposed, for example, as follows.

The portion 10b is disposed along the side surface 2d. The portion 10b is disposed at a substantially central portion of the element body 2 in the direction D1. The portion 10c is disposed along the side surface 2c. The portion 10c is disposed at a substantially central portion of the element body 2 in the direction D1.

The portion 10d is connected to an end that is included in the portion 10b and is near the end surface 2a, and is disposed along the end surface 2a. The portion 10e is connected to an end that is included in the portion 10b and is near the end surface 2b, and is disposed along the end surface 2b. The portion 10e has, for example, the same shape as the portion 10d.

The portion 10f connects an end that is included in the portion 10c and is near the end surface 2a and an end that is included in the portion 10d and is near the side surface 2c. The portion 10g connects an end that is included in the portion 10c and is near the end surface 2b and an end that is included in the portion 10e and is near the side surface 2c.

The coil conductor 5c includes one end of the coil 10. The one end of the coil conductor 5c and the connection conductor 6 are adjacent to each other in the direction D1 and are connected to each other. The other end of the coil conductor 5c and one end of the coil conductor 5d are adjacent to each other in the direction D3 and are connected to each other. The other end of the coil conductor 5d and one end of the coil conductor 5e are adjacent to each other in the direction D3 and are connected to each other. The other end of the coil conductor 5e and one end of the coil conductor 5f are adjacent to each other in the direction D3 and are connected to each other. The other end of the coil conductor 5f and the connection conductor 7 are adjacent to each other in the direction D1 and are connected to each other. The coil conductor 5f includes the other end of the coil 10.

The coil conductor 5c is, for example, configured through laminating a plurality of conductor layers 15c. The coil conductor 5c includes the plurality of laminated conductor layers 15c. In the coil conductor 5c, a lamination direction of the plurality of conductor layers 15c coincides with the direction D3. In an actual coil conductor 5c, the plurality of conductor layers 15c are integrated to an extent that boundaries between the layers cannot be visually recognized. The plurality of conductor layers 15c are disposed to overlap each other as a whole, when viewed from the direction D3. The coil conductor 5c may include only a single conductor layer 15c.

The coil conductor 5d is, for example, configured through laminating a plurality of conductor layers 15d. The coil conductor 5d includes the plurality of laminated conductor layers 15d. In the coil conductor 5d, a lamination direction of the plurality of conductor layers 15d coincides with the direction D3. In an actual coil conductor 5d, the plurality of conductor layers 15d are integrated to an extent that boundaries between the layers cannot be visually recognized. The plurality of conductor layers 15d are disposed to overlap each other as a whole, when viewed from the direction D3. The coil conductor 5d may include only a single conductor layer 15d.

The coil conductor 5e is, for example, configured through laminating a plurality of conductor layers 15e. The coil conductor 5e includes the plurality of laminated conductor layers 15e. In the coil conductor 5e, a lamination direction of the plurality of conductor layers 15e coincides with the direction D3. In an actual coil conductor 5e, the plurality of conductor layers 15e are integrated to an extent that boundaries between the layers cannot be visually recognized. The plurality of conductor layers 15e are disposed to overlap each other as a whole, when viewed from the direction D3. The coil conductor 5e may include only a single conductor layer 15e.

The coil conductor 5f is, for example, configured through laminating a plurality of conductor layers 15f. The coil conductor 5f includes the plurality of laminated conductor layers 15f. In the coil conductor 5f, a lamination direction of the plurality of conductor layers 15f coincides with the direction D3. In an actual coil conductor 5f, the plurality of conductor layers 15f are integrated to an extent that boundaries between the layers cannot be visually recognized. The plurality of conductor layers 15f are disposed to overlap each other as a whole, when viewed from the direction D3. The coil conductor 5f may include only a single conductor layer 15f.

FIG. 2 illustrates only one each of the conductor layers 15c, 15d, 15e, and 15f.

The connection conductor 6 extends in the direction D1 and couples the coil conductor 5c and the conductor portion 42. The connection conductor 6 is, for example, configured through laminating a plurality of conductor layers 16. The connection conductor 6 includes the plurality of laminated conductor layers 16. In the connection conductor 6, a lamination direction of the plurality of conductor layers 16 coincides with the direction D3. In an actual connection conductor 6, the plurality of conductor layers 16 are integrated to an extent that boundaries between the layers cannot be visually recognized. The plurality of conductor layers 16 are disposed to overlap each other as a whole, when viewed from the direction D3. The connection conductor 6 may include only one conductor layer 16.

The connection conductor 7 extends in the direction D1 and couples the coil conductor 5f and the conductor portion 32. The connection conductor 7 is, for example, configured through laminating a plurality of conductor layers 17. The connection conductor 7 includes the plurality of laminated conductor layers 17. In the connection conductor 7, a lamination direction of the plurality of conductor layers 17 coincides with the direction D3. In an actual connection conductor 7, the plurality of conductor layers 17 are integrated to an extent that boundaries between the layers cannot be visually recognized. The plurality of conductor layers 17 are disposed to overlap each other as a whole, when viewed from the direction D3. The connection conductor 7 may include only one conductor layer 17.

FIG. 2 illustrates only one each of the conductor layers 16 and 17.

Each of the plurality of conductor layers 13, 14, 15c, 15d, 15e, 15f, 16, and 17 includes an electrically conductive material. Each of the plurality of conductor layers 13, 14, 15c, 15d, 15e, 15f, 16, and 17 is, for example, made of an electrically conductive material. The electrically conductive material includes, for example, Ag or Pd. Each of the plurality of conductor layers 13, 14, 15c, 15d, 15e, 15f, 16, and 17 may be made of the same electrically conductive material, or may be made of different electrically conductive materials. Each of the plurality of conductor layers 13, 14, 15c, 15d, 15e, 15f, 16, and 17 has a substantially rectangular cross-sectional shape.

The coil component 1 includes a plurality of layers La, Lb, Lc, Ld, Le, and Lf. The coil component 1 includes, for example, in order from the side surface 2f toward the side surface 2e, two layers La, one layer Lb, three layers Lc, three layers Ld, three layers Le, three layers Lf, one layer Lb, and two layers La. The coil component 1 is configured through laminating a plurality of layers La, Lb, Lc, Ld, Le, and Lf. The coil component 1 includes the plurality of laminated layers La, Lb, Lc, Ld, Le, and Lf.

Regarding the plurality of layers Lc, Ld, Le, and Lf, FIG. 2 illustrates only one each of the layers Lc, Ld, Le, and Lf, and omits illustration of the other two layers Lc, two layers Ld, two layers Le, and two layers Lf.

The layer La includes the element-body layer 12a.

The layer Lb includes the element-body layer 12b, the conductor layer 13, and the conductor layer 14. The layer Lb is configured by the element-body layer 12b, and the conductor layer 13 and the conductor layer 14 being combined with each other. In the element-body layer 12b, an opening Rb corresponding to the conductor layer 13 and an opening Rb corresponding to the conductor layer 14 are formed. The opening Rb corresponding to the conductor layer 13 is formed in a shape corresponding to the shape of the conductor layer 13. The conductor layer 13 is located in the opening Rb corresponding to the conductor layer 13. The opening Rb corresponding to the conductor layer 14 is formed in a shape corresponding to the shape of the conductor layer 14. The conductor layer 14 is located in the opening Rb corresponding to the conductor layer 14. The element-body layer 12b has a complementary relationship with the conductor layer 13 and the conductor layer 14.

The layer Lc includes the element-body layer 12c, the conductor layer 13, the conductor layer 14, the conductor layer 15c, and the conductor layer 16. The layer Lc is configured by the element-body layer 12c, the conductor layer 13, the conductor layer 14, the conductor layer 15c, and the conductor layer 16 being combined with each other. In the element-body layer 12c, an opening Rc corresponding to the conductor layer 13, an opening Rc corresponding to the conductor layer 14, an opening Rc corresponding to the conductor layer 15c, and an opening Rc corresponding to the conductor layer 16 are formed. The opening Rc corresponding to the conductor layer 13 has a shape corresponding to the shape of the conductor layer 13. The conductor layer 13 is located in the opening Rc corresponding to the conductor layer 13. The opening Rc corresponding to the conductor layer 14 has a shape corresponding to the shape of the conductor layer 14. The conductor layer 14 is located in the opening Rc corresponding to the conductor layer 14. The opening Rc corresponding to the conductor layer 15c has a shape corresponding to the shape of the conductor layer 15c. The conductor layer 15c is located in the opening Rc corresponding to the conductor layer 15c. The opening Rc corresponding to the conductor layer 16 has a shape corresponding to the shape of the conductor layer 16. The conductor layer 16 is located in the opening Rc corresponding to the conductor layer 16. The element-body layer 12c has a complementary relationship with the conductor layer 13, the conductor layer 14, the conductor layer 15c, and the conductor layer 16.

The layer Ld includes the element-body layer 12d, the conductor layer 13, the conductor layer 14, and the conductor layer 15d. The layer Ld is configured by the element-body layer 12d, the conductor layer 13, the conductor layer 14, and the conductor layer 15d being combined with each other. In the element-body layer 12d, an opening Rd corresponding to the conductor layer 13, an opening Rd corresponding to the conductor layer 14, and an opening Rd corresponding to the conductor layer 15d are formed. The opening Rd corresponding to the conductor layer 13 has a shape corresponding to the shape of the conductor layer 13. The conductor layer 13 is located in the opening Rd corresponding to the conductor layer 13. The opening Rd corresponding to the conductor layer 14 has a shape corresponding to the shape of the conductor layer 14. The conductor layer 14 is located in the opening Rd corresponding to the conductor layer 14. The opening Rd corresponding to the conductor layer 15d has a shape corresponding to the shape of the conductor layer 15d. The conductor layer 15d is located in the opening Rd corresponding to the conductor layer 15d. The element-body layer 12d has a complementary relationship with the conductor layer 13, the conductor layer 14, and the conductor layer 15d.

The layer Le includes the element-body layer 12e, the conductor layer 13, the conductor layer 14, and the conductor layer 15e. The layer Le is configured by the element-body layer 12e, the conductor layer 13, the conductor layer 14, and the conductor layer 15e being combined with each other. In the element-body layer 12e, an opening Re corresponding to the conductor layer 13, an opening Re corresponding to the conductor layer 14, and an opening Re corresponding to the conductor layer 15e are formed. The opening Re corresponding to the conductor layer 13 has a shape corresponding to the shape of the conductor layer 13. The conductor layer 13 is located in the opening Re corresponding to the conductor layer 13. The opening Re corresponding to the conductor layer 14 has a shape corresponding to the shape of the conductor layer 14. The conductor layer 14 is located in the opening Re corresponding to the conductor layer 14. The opening Re corresponding to the conductor layer 15e has a shape corresponding to the shape of the conductor layer 15e. The conductor layer 15e is located in the opening Re corresponding to the conductor layer 15e. The element-body layer 12e has a complementary relationship with the conductor layer 13, the conductor layer 14, and the conductor layer 15e.

The layer Lf includes the element-body layer 12f, the conductor layer 13, the conductor layer 14, the conductor layer 15f, and the conductor layer 17. The layer Lf is configured by the element-body layer 12f, the conductor layer 13, the conductor layer 14, the conductor layer 15f, and the conductor layer 17 being combined with each other. In the element-body layer 12f, an opening Rf corresponding to the conductor layer 13, an opening Rf corresponding to the conductor layer 14, an opening Rf corresponding to the conductor layer 15f, and an opening Rf corresponding to the conductor layer 17 are formed. The opening Rf corresponding to the conductor layer 13 has a shape corresponding to the shape of the conductor layer 13. The conductor layer 13 is located in the opening Rf corresponding to the conductor layer 13. The opening Rf corresponding to the conductor layer 14 has a shape corresponding to the shape of the conductor layer 14. The conductor layer 14 is located in the opening Rf corresponding to the conductor layer 14. The opening Rf corresponding to the conductor layer 15f has a shape corresponding to the shape of the conductor layer 15f. The conductor layer 15f is located in the opening Rf corresponding to the conductor layer 15f. The opening Rf corresponding to the conductor layer 17 has a shape corresponding to the shape of the conductor layer 17. The conductor layer 17 is located in the opening Rf corresponding to the conductor layer 17. The element-body layer 12f has a complementary relationship with the conductor layer 13, the conductor layer 14, the conductor layer 15f, and the conductor layer 17.

The openings Rb, Rc, Rd, Re, and Rf corresponding to the conductor layer 13 are integrated to constitute recesses 21 and 22. The openings Rb, Rc, Rd, Re, and Rf corresponding to the conductor layer 14 are integrated to constitute recesses 23 and 24. Each width of the plurality of openings Rb, Rc, Rd, Re, and Rf is basically larger than the width of the corresponding conductor layer. In order to improve adhesion between the element-body layer and the conductor layer in each of the plurality of layers Lb, Lc, Ld, Le, and Lf, each width of the plurality of openings Rb, Rc, Rd, Re, and Rf may be smaller than the width of the corresponding conductor layer. A value obtained by subtracting the width of the corresponding conductor layer from each width of the plurality of openings Rb, Rc, Rd, Re, and Rf is, for example, larger than or equal to -3 μm and less than or equal to 10 μm. A value obtained by subtracting the width of the corresponding conductor layer from each width of the plurality of openings Rb, Rc, Rd, Re, and Rf may be, for example, larger than or equal to 0 μm and less than or equal to 10 μm.

As illustrated in FIG. 4, the element body 2 includes a region 2_{R1} in which the coil 10 is located, and a pair of regions 2_{R2} located on both sides of the region 2_{R1}. The region 2_{R1} includes the element-body layer 12b, the element-body layer 12c, the element-body layer 12d, the element-body layer 12e, and the element-body layer 12f. Each of the pair of regions 2_{R2} includes the element-body layer 12a.

The ratio of a thickness TH2 of each of the pair of regions 2_{R2} to a thickness TH1 of the region 2_{R1} is from 0.15 to 0.30. The thickness TH1 is, for example, from 74 μm to 94 μm. The thickness TH1 is, for example, 84 μm. The thickness TH2 is, for example, from 14 μm to 22 μm. The thickness TH2 is, for example, 18 μm.

For example, where the region 2_{R1} includes a first region, the region 2_{R2} includes a second region.

The region 2_{R1} is made of glass-ceramic, as described above. The region 2_{R1} includes, for example, SiO₂, Al₂O₃, SrO, B₂O₃, and K₂O.

The region 2_{R1} includes, as a microstructure, for example, a phase including a glass component, a phase including an Al₂O₃ filler, and a phase including an SiO₂ filler. The phase including the glass component includes, for example, a feldspar crystal phase and an amorphous glass phase. The Al₂O₃ included in the region 2_{R1} after firing is derived from the Al₂O₃ filler. Therefore, the total content of the Al₂O₃ filler included in the region 2_{R1} can be defined by the total content of Al₂O₃ included in the region 2_{R1} after firing.

The feldspar crystal phase is a phase that mainly includes feldspar crystals. The feldspar crystals are crystals including a Group 2 metal element (excluding Be), alumina, and silica, and are represented by the general formula M(Si, Al)₄O₈. M is a Group 2 metal element (excluding Be). M may be mainly Sr. The description "M is mainly Sr" includes that the content ratio of Sr on a mass basis is the largest among the elements included as M in the feldspar crystals. The simple description "the feldspar crystal phase mainly includes Sr" may include that the content ratio of Sr is the largest on a mass basis, among the elements included as M in the feldspar crystals included in the feldspar crystal phase. The feldspar crystal phase may include a metal oxide in addition to the feldspar crystals. The metal oxide includes, for example, Na₂O, K₂O, ZrO₂, or Ag₂O. The proportion of the feldspar crystals in the feldspar crystal phase is not particularly limited. The proportion of the feldspar crystals in the feldspar crystal phase may be, for example, 80% by mass or more.

The amorphous glass phase is a phase made of glass that does not include crystals. The composition of the glass included in the amorphous glass phase is not particularly limited. For example, the amorphous glass phase may include an oxide of M, an oxide of Si, an oxide of Al, and an oxide of B in a total amount of 70% by mass or more.

The phase including the Al₂O₃ filler is a phase that mainly includes crystals of Al₂O₃. The proportion of Al₂O₃ in the phase including the Al₂O₃ filler is not particularly limited. For example, the proportion of Al₂O₃ in the phase including the Al₂O₃ filler may be 97% by mass or more.

A plurality of phases including the Al₂O₃ filler may be bonded via the feldspar crystal phase. It is not necessary that all the phases including the Al₂O₃ filler be bonded via the feldspar crystal phase. It is sufficient that at least one pair of phases including the Al₂O₃ filler be bonded via the feldspar crystal phase. Among the plurality of phases including the Al₂O₃ filler, 25% or more of the phases by number may be bonded to other phases including the Al₂O₃ filler via the feldspar crystal phase.

The phase including the SiO₂ filler is a phase mainly including SiO₂. The proportion of SiO₂ in the phase including the SiO₂ filler is not particularly limited. The proportion of SiO₂ in the phase including the SiO₂ filler may be, for example, 97% by mass or more.

In the glass-ceramic including the phase including the glass component, the phase including the Al₂O₃ filler, and the phase including the SiO₂ filler, for example, the relative permittivity is low and the strength is high.

The phase including the SiO₂ filler and the amorphous glass phase are usually included in an amorphous phase. In a glass-ceramic including a large amount of the amorphous phase, the relative permittivity tends to be low. However, in a glass-ceramic including a large amount of the amorphous phase, cracks tend to occur, and the strength tends to decrease.

The phase including the Al₂O₃ filler is usually included in a crystalline phase. In a glass-ceramic including the crystalline phase, the relative permittivity tends to be high, and the strength tends not to be sufficiently high. However, in a glass-ceramic that includes the phase including the Al₂O₃ filler and the feldspar crystal phase, and in which the phase including the Al₂O₃ filler is bonded via the feldspar crystal phase, the relative permittivity is low and the strength is high.

The region 2_{R2} is made of glass-ceramic, as described above. The region 2_{R2}, for example, includes Al₂O₃, SiO₂, SrO, B₂O₃, CaO, MgO, and K₂O after firing.

The region 2_{R2}, as a microstructure, includes, for example, a phase including a glass component, a phase including an Al₂O₃ filler, and a phase including an SiO₂ filler. The phase including the glass component, for example, includes an amorphous glass phase. The content of Al₂O₃ included in the region 2_{R2} after firing is derived from the Al₂O₃ filler. Therefore, the total content of the Al₂O₃ filler included in the region 2_{R2} can be defined by the total content of Al₂O₃ included in the region 2_{R2} after firing. The total content of the Al₂O₃ filler included in the region 2_{R2} is larger than the total content of the Al₂O₃ filler included in the region 2_{R1}.

As illustrated in FIG. 4, the element body 2 includes plate-like Al₂O₃ fillers F1 and F3 and granular Al₂O₃ fillers F2 and F4 in the phase including Al₂O₃ filler. FIG. 4 is a diagram illustrating a cross-sectional configuration of an element body. In FIG. 4, the Al₂O₃ filler is schematically illustrated in the cross-sectional configuration of the element body 2. The shape and size of the Al₂O₃ filler illustrated in FIG. 4 may differ from the actual shape and size of the Al₂O₃ filler. In FIG. 4, hatching indicating a cross section is omitted. FIG. 4 includes a plurality of enlarged views of a part of the element body 2.

The region 2_{R1} includes a plurality of plate-like Al₂O₃ fillers F1 and a plurality of granular Al₂O₃ fillers F2. In the region 2_{R1}, for example, the content of the plate-like Al₂O₃ filler F1 is from 18 to 25 wt%, and the content of the granular Al₂O₃ filler F2 is from 3 to 5 wt%. In the region 2_{R1}, for example, the content of the plate-like Al₂O₃ filler F1 is 22.3 wt%, and the content of the granular Al₂O₃ filler F2 is 4.3 wt%.

The region 2_{R2} includes a plurality of plate-like Al₂O₃ fillers F3 and a plurality of granular Al₂O₃ fillers F4. The plate-like Al₂O₃ filler F3 may be the same type of Al₂O₃ filler as the plate-like Al₂O₃ filler F1. The granular Al₂O₃ fillers F4 may be the same type of Al₂O₃ filler as the granular Al₂O₃ filler F2.

In the region 2_{R2}, for example, the content of the plate-like Al₂O₃ filler F3 is from 3 to 8 wt%, and the content of the granular Al₂O₃ filler F4 is from 26 to 38 wt%. In the region 2_{R2}, for example, the content of the plate-like Al₂O₃ filler F3 is 5.3 wt%, and the content of the granular Al₂O₃ filler F4 is 32.4 wt%.

In the region 2_{R2}, the plate-like Al₂O₃ filler F3 is oriented in a direction transverse to the thickness direction of the region 2_{R2}. The thickness direction in the region 2_{R2} includes the direction D3, that is, the direction in which the side surface 2e and the side surface 2f oppose each other.

The plate-like Al₂O₃ fillers F1 and F3 have a substantially plate-like cross-section. The plate-like Al₂O₃ fillers F1 and F3, for example, have a cross-sectional shape having a major axis in the longest direction, and a minor axis that is perpendicular to the major axis and is in the shortest direction. The plate-like Al₂O₃ fillers F1 and F3 each have an aspect ratio of, for example, 15 or more and 75 or less. The aspect ratio of each of the plate-like Al₂O₃ fillers F1 and F3 can be defined, for example, as a ratio of the length in the major axis direction to the length in the minor axis direction. The average particle size of the plate-like Al₂O₃ fillers F1 and F3 is, for example, 0.3 μm or more and 3.0 μm or less.

The granular Al₂O₃ fillers F2 and F4 have a substantially polygonal or substantially circular cross-section. The granular Al₂O₃ fillers F2 and F4 each have an aspect ratio of, for example, 1 or more and 5 or less. The granular Al₂O₃ fillers F2 and F4 include, for example, spherical or polyhedral Al₂O₃ fillers. The average particle size of the granular Al₂O₃ fillers F2 and F4 is, for example, 0.3 μm or more and 3.0 μm or less.

Each of the Al₂O₃ fillers F1, F2, F3, and F4 may have a smooth surface or may have a rough surface.

The average particle size can be defined, for example, by a volume-based median diameter (d50) in a laser diffraction particle size distribution measurement.

In the coil component 1, the region 2_{R1} and the region 2_{R2} include the Al₂O₃ filler. Therefore, the coil component 1 improves the strength of the element body 2.

The Al₂O₃ filler tends to increase the relative permittivity of the element body 2. The coil 10 is located in the region 2_{R1}. The region 2_{R1} in which the coil 10 is located tends to contribute to the characteristics of the coil 10, as compared with the region 2_{R2}. In the coil component 1, the total content of the Al₂O₃ filler in the region 2_{R1} is smaller than the total content of the Al₂O₃ filler in the region 2_{R2}. The coil component 1 suppresses an increase in the relative permittivity of the element body 2. In the coil component 1, the total content of the Al₂O₃ filler in the region 2_{R2} is larger than the total content of the Al₂O₃ filler in the region 2_{R1}. The coil component 1 suppresses a decrease in the strength of the element body 2.

In the coil component 1, the region 2_{R1} includes the plate-like Al₂O₃ filler F1 and the granular Al₂O₃ filler F2, and the region 2_{R2} includes the plate-like Al₂O₃ filler F3 and the granular Al₂O₃ filler F4. In the coil component 1, a rapid structural change tends not to occur between the region 2_{R1} and the region 2_{R2}, as compared with a configuration in which one of the region 2_{R1} and the region 2_{R2} includes plate-like Al₂O₃ filler and the other of the region 2_{R1} and the region 2_{R2} includes granular Al₂O₃ filler. For example, a difference between the shrinkage rate of the region 2_{R1} and the shrinkage rate of the region 2_{R2} tends not to be large. Therefore, internal stress tends not to occur in the element body 2. The coil component 1 suppresses the occurrence of cracks in the element body 2.

The plate-like Al₂O₃ filler, for example, tends to be oriented in a predetermined direction. In a region including the plate-like Al₂O₃ filler, a difference in strength may occur between a direction in which the plate-like Al₂O₃ filler is oriented and a direction other than the direction in which the plate-like Al₂O₃ filler is oriented. The difference in strength due to the direction in which the plate-like Al₂O₃ filler is oriented may cause cracks to occur in the region including the plate-like Al₂O₃ filler when an external force is applied.

In the coil component 1, the content of the plate-like Al₂O₃ filler F3 in the region 2_{R2} is smaller than the content of the plate-like Al₂O₃ filler F1 in the region 2_{R1}. In the region 2_{R2} that is located outside the region 2_{R1} and protects the region 2_{R1}, a difference in strength due to the direction in which the plate-like Al₂O₃ filler F3 is oriented tends not to occur. Therefore, even when an external force is applied to the region 2_{R2}, cracks tend not to occur in the region 2_{R2}. The coil component 1 tends not to degrade the function of the region 2_{R2} to protect the region 2_{R1}.

In the region 2_{R2}, the plate-like Al₂O₃ filler F3 may be oriented in a direction transverse to the thickness direction of the region 2_{R2}.

In a configuration in which the plate-like Al₂O₃ filler F3 in the region 2_{R2} is oriented in a direction transverse to the thickness direction of the region 2_{R2}, this configuration reliably maintains the strength of the coil component 1 (element body 2) even when an external force acts on the coil component 1 (element body 2) in the thickness direction of the region 2_{R2}.

A ratio of the thickness TH2 of each of the pair of regions 2_{R2} to the thickness TH1 of the region 2_{R1} may be from 0.15 to 0.30.

A configuration in which the above-described ratio is 0.15 or more contributes to reliably maintaining the strength of the coil component 1 (element body 2).

A configuration in which the above-described ratio is 0.30 or less contributes to reliably maintaining the thickness of the region 2_{R1} in which the coil 10 is disposed. Therefore, this configuration can, for example, reliably maintain the number of turns of the coil 10. This configuration can, for example, reliably maintain the inductance of the coil component 1.

The total content of the Al₂O₃ filler may be obtained, for example, based on the area of the Al₂O₃ filler in a cross-sectional photograph of the element body 2 including the region 2_{R1} and the pair of regions 2_{R2}.

A cross-sectional photograph of the element body 2 including the region 2_{R1} and the pair of regions 2_{R2} is obtained. The cross-sectional photograph is, for example, a photograph taken of a cross-section when the element body 2 is cut along a plane parallel to the pair of end surfaces 2a and 2b. The cross-sectional photograph may include, for example, an SEM (Scanning Electron Microscope) photograph. The obtained cross-sectional photograph is subjected to image processing using software to determine boundaries of the Al₂O₃ filler, and the total area of the Al₂O₃ filler included per predetermined unit area within the cross-sectional photograph is obtained in each of the region 2_{R1} and the regions 2_{R2}. In each of the region 2_{R1} and the regions 2_{R2}, the total area of the Al₂O₃ filler is divided by the predetermined unit area, and a value expressed as a percentage is obtained. This value may be used as the total content of the Al₂O₃ filler.

The content of the plate-like Al₂O₃ filler may be obtained, for example, based on the area of the plate-like Al₂O₃ filler in a cross-sectional photograph of the element body 2 including the region 2_{R1} and the pair of regions 2_{R2}.

A cross-sectional photograph of the element body 2 including the region 2_{R1} and the pair of regions 2_{R2} is obtained. The cross-sectional photograph is, for example, a photograph taken of a cross-section when

the element body 2 is cut along a plane parallel to the pair of end surfaces 2a and 2b. The cross-sectional photograph may include, for example, an SEM (Scanning Electron Microscope) photograph. The obtained cross-sectional photograph is subjected to image processing using software to determine boundaries of the plate-like Al₂O₃ filler, and the total area of the plate-like Al₂O₃ filler included per predetermined unit area within the cross-sectional photograph is obtained in each of the region 2_{R1} and the regions 2_{R2}. In each of the region 2_{R1} and the regions 2_{R2}, the total area of the plate-like Al₂O₃ filler is divided by the predetermined unit area, and a value expressed as a percentage is obtained. This value may be used as the content of the plate-like Al₂O₃ filler.

It is to be understood that not all aspects, advantages and features described herein may necessarily be achieved by, or included in, any one particular example. Indeed, having described and illustrated various examples herein, it should be apparent that other examples may be modified in arrangement and detail.

For example, the number of turns of the coil 10 is not limited to the illustrated number. For example, the number of the plurality of coil conductors 5c, 5d, 5e, and 5f is not limited to the illustrated number. For example, the number of the plurality of element-body layers 12a to 12f is not limited to the illustrated number.

For example, among the plurality of coil conductors 5c, 5d, 5e, and 5f, coil conductors adjacent to each other in the direction D3 may not be directly connected to each other. For example, among the plurality of coil conductors 5c, 5d, 5e, and 5f, the electrical connection between the coil conductors adjacent to each other in the direction D3 may be realized by a through-hole conductor.

What is claimed is:

1. A coil component comprising:
an element body made of an insulator including Al₂O₃ filler; and a coil disposed in the element body, wherein
the element body includes:
a first region in which the coil is located, the first region including plate-like Al₂O₃ filler and granular Al₂O₃ filler as the Al₂O₃ filler, and
a pair of second regions located on both sides of the first region, the pair of second regions including plate-like Al₂O₃ filler and granular Al₂O₃ filler as the Al₂O₃ filler, and
each of the pair of second regions has a total content of the Al₂O₃ filler larger than a total content of the Al₂O₃ filler in the first region, and has a content of the plate-like Al₂O₃ filler smaller than a content of the plate-like Al₂O₃ filler in the first region.

2. The coil component according to claim 1, wherein
in each of the pair of second regions, the plate-like Al₂O₃ filler is oriented in a direction transverse to a thickness direction of the second region.

3. The coil component according to claim 1, wherein
a ratio of a thickness of each of the pair of second regions to a thickness of the first region is from 0.15 to 0.30.

4. The coil component according to claim 1, wherein
the insulator includes a glass-ceramic.

5. The coil component according to claim 1, further comprising a plurality of external conductors disposed on the element body and electrically connected to the coil.

6. The coil component according to claim 5, wherein
the plurality of external conductors disposed on the first region.

7. The coil component according to claim 1, wherein
the element body includes a plurality of laminated element-body layers, and
the first region is located between the pair of second regions in a lamination direction of the plurality of element-body layers.

8. The coil component according to claim 1, wherein
the coil includes a plurality of coil conductor electrically connected to each other and disposed in a direction, and
the first region is located between the pair of second regions in the direction in which the plurality of coil conductor are disposed.
